(19) United States
(12) Patent Application Publication
(10) Pub. No.: US 2015/0220189 A1
(43) Pub. Date: Aug. 6, 2015

(54) PATTERNED CONDUCTOR TOUCH SCREEN

(71) Applicant: Oerlikon Advanced Technologies AG, Balzers (LI)

(72) Inventors: Oliver Rattunde, Werdenberg (CH); Martin Dubs, Maienfeld (CH)

(21) Appl. No.: 14/422,845

(22) PCT Filed: Aug. 23, 2013
(86) PCT No.: PCT/EP2013/067516

§ 371 Date: Feb. 20, 2015

Related U.S. Application Data
(60) Provisional application No. 61/693,846, filed on Aug. 28, 2012.

(51) Int. Cl. G06F 3/041

(52) U.S. Cl. CPC G06F 3/0412

(57) ABSTRACT

A touch screen and a method to manufacture a touch screen having a substrate and a patterned transparent conductor layer. The color difference between substrate areas with and without coverage by the transparent conductor layer with respect to both reflectance and transmittance is reduced by an intermediate layer stack (IL) disposed between the substrate and the transparent conductor layer. The intermediate layer stack includes a plurality of at least two alternating high refractive index and low refractive index materials. In a second embodiment of a touch screen and a method to manufacture a touch screen, a capping layer (CL) is situated on top of the patterned transparent conductor layer and the intermediate layer (IL) where it is not covered by the patterned transparent conductor layer.

### FIELD OF THE INVENTION

This invention relates to touch screens, and particularly to on-display touch screens that utilize a pattern of transparent conductors as the touch sensing elements and a method of manufacturing such touch screens.

### BACKGROUND OF THE INVENTION AND RELATED ART

Touch screens have become an increasingly common way for users to intuitively interact with electronic systems, typically those that include displays for viewing information. Transparent touch screens can be disposed over variable displays and/or static images so that the displayed information and images can be viewed through the touch screen. Touch screen technologies suitable for use in such configurations include resistive, capacitive, projected capacitive, inductive, surface acoustic wave, force, and others.

Transparent touch screens utilize a substantially transparent substrate (e.g. glass or PET) and one or two patterned layers made of transparent conductive material (e.g. ITO, Indium Tin Oxide) for sensing the location of the user input.

One important parameter of the conductive material film is its sheet resistance measured in Ω/sq. Depending on the attached electronics typical touch screen applications work with sheet resistance values ranging from 10-100 Ω/sq with smaller sheet resistance requiring thicker film thicknesses of the transparent conductive material.

Another important performance parameter is overall transmittance of the transparent touch screen device which should be as high as possible. Desirable transmittance values are 90% and more.

Since the transparent conductor layer is patterned and therefore not uniformly distributed over the substrate, reflectance and transmittance differ when areas with and without the transparent conducting layer respectively are compared. Thus the pattern becomes visible to the touch screen user. This so-called “pattern visibility” must be minimized since it may disturb the transmission of information from the display and/or for pure cosmetic reasons. In other words, the color difference between substrate areas with and without coverage of the transparent conductor layer in both reflectance and transmittance should be reduced.

### DEFINITIONS

Color difference in this context refers to the difference in optical signal reflected from or transmitted through the touch screen in the spectral range which is visible to the human end-user of the touch screen device—thus a spectral range from 380-780 nm must be taken into account. The optical signal may be either the transmittance or the reflectance of the touch screen including the substantially transparent substrate, the patterned conductive layer, and a plurality of optional layers intended for reducing color difference between areas with and without coverage with the conductive layer.

One way of quantifying color difference (sometimes also called “color distance”) with respect to the sensitivity of the human eye applies the CIELAB color space defining ΔE according to

ΔE=sqrt ((L2−L1)\hat{2}+(a2−a1)\hat{2}+(b2−b1)\hat{2})**squrt=squareroot

for two colors having the CIELAB color coordinates (L1, a1, b1) and (L2, a2, b2) respectively. Color coordinates are calculated from either transmittance or reflectance with respect to a dedicated illumination. All further ΔE-values are calculated using SI D65 illumination data for average daylight/midday sun in Western Europe also known as CIE Standard Illumination D65 or D₆₅.

All refractive index values used within this document give refer to a wavelength of 633 nm.

### GENERAL DESCRIPTION

In a first aspect the invention refers to a touch screen having a substrate and a patterned transparent conductor layer wherein the color difference between substrate areas with and without coverage by the transparent conductor layer with respect to both reflectance and transmittance is reduced by the following features:
an intermediate layer stack (IL) is disposed between the substrate and the transparent conductor layer,
wherein the intermediate layer stack comprises a plurality of at least two alternating high refractive index and low refractive index materials.

The touch screen can be transparent having a substantially transparent substrate. The refractive index of the latter can be chosen between 1.5 and 1.6 with the limits included. Appropriate materials for as mentioned transparent substrates would be glass or Polyethylenterephthalate (PET) as examples.

Hereby and for all limits disclosed in this document it should be understood that limits are always considered to be included together with the range defined thereby. It should be further understood that all aspects of the invention as disclosed above and in the following can be combined freely as far as this does not refer to contradictory aspects.

With reference to the refractive index of the patterned transparent conductor layer a range between 1.8 and 2.0 can be chosen. A well-known example for the material of such transparent conductors is Indium Tin Oxide (ITO).

Further aspects of the invention refer to the different refractive materials of the intermediate layer (IL). A high refractive index material having a refractive index between 2.25 and 2.4, preferably between 2.3 to 2.4 was found to be appropriate. Niobiumpentoxide Nb₂O₅ and Titaniumoxid TiO₂ are two examples of such high refractive index materials.

Whereas for the low refractive index material a refractive index between 1.3 and 1.6, preferably about 1.46 was used and Silicon Oxide SiO₂ is an example for the low refractive index material.

A further aspect of the invention refers to touch screens having a thin film thickness of the transparent conductor layer film that is to say 30 nm or less.

Several aspects of the invention refer to the design of the intermediate layer stack (IL). With a two layer IL e.g. a design with a high refractive index material layer of 6±1 nm thickness deposited on the substrate and a low refractive index material layer of 56±6 nm on top of the high refractive index material layer can be used. Such a basic design can be used advantageously for as mentioned touch screens provided with a thin transparent conductor layer film.

For increasing film thickness of the transparent conductor layer film a more sophisticated IL design comprising a set of at least four layers of alternating high refractive index and low refractive index materials might be used. The following design gives an example of a four layer IL comprising
a first layer of high reflective material having a thickness between 1 and 10 nm, preferably between 2 and 9 nm, especially preferably between 3.6 and 7.8 nm,
a first layer of low reflective material having a thickness between 60 and 72 nm, preferably between 63 and 69 nm, especially preferably between 63.3 and 68.2 nm,
a second layer of high reflective material having a thickness between 8 and 21 nm, preferably between 10 and 19 nm, especially preferably between 10.1 and 17.2 nm,
a second layer of low reflective material having a thickness between 48 and 62 nm, preferably between 50 and 60 nm, especially preferably between 50.0 and 60.3 nm.

The average overall transmittance of the touch screen of the actual invention in a wavelength range between 380 and 780 nm should be at least about 90%, the maximum color difference ΔE between substrate areas with and without coverage by the transparent conductor layer should be ΔEₜᵣₐₙₛ≦0.6 for the transmittance and ΔE_{ref1}≦1.6 for the reflectance and ΔE_{ref1}_{_{—}}₄₅≦1.5 for the 45° reflectance.

A further aspect of the invention refers to touch screens having a relatively high thickness of the transparent conductor layer film e.g. a film thickness of 40 nm or more.

Not only, but particularly with regard to such thicker transparent conductor layer films, touch screens comprising a capping layer (CL) situated on top of the patterned transparent conductor layer and the intermediate layer (IL), where it is not covered by the patterned transparent conductor layer, can be used.

A capping layer CL comprising at least two layers of at least two alternating high refractive index and low refractive index materials can be used advantageously. To reach an appropriate result however, thick capping layers with reference to the thickness of the transparent conductor layer should be used. As an example the capping layer may have at least 10 (ten) times or in certain instances even at least 15 (fifteen) times the thickness of the patterned transparent conductor layer. In other numbers the thickness of the capping layer CL can be between 600 and 1100 nm, preferably between 700 and 1000 nm with reference to materials as used for experimental data as disclosed under detailed description below. The practitioner however knows how to adapt film thicknesses in order to reach the same optical thickness nᵢ×dᵢ with materials of different optical refractive index.

This in mind a capping layer CL comprising at least two layers of at least two alternating high refractive index and low refractive index materials may be designed with a high refractive index material layer of 800±100 nm thickness deposited on the patterned transparent conductor layer and the intermediate layer (IL), where it is not covered by the transparent conductor layer, and a low refractive index material layer of 75±10 nm thickness deposited on top of the high refractive index material.

A further aspect of the invention is to disclose a method of manufacturing a touch screen, with reduced color difference ΔE between substrate areas with and without coverage by a transparent conductor layer, by applying an intermediate layer stack (IL) whereby:
first an intermediate layer stack (IL) comprising a plurality of at least two alternating high refractive index and low refractive index materials is deposited on the substrate and
   a layer of high refractive index material is deposited directly on the substrate and
secondly the patterned transparent conductor layer is deposited on top of the intermediate layer stack (IL).

A further aspect of the invention is to disclose a method of manufacturing a touch screen, with reduced color difference ΔE between substrate areas with and without coverage by a transparent conductor layer, by applying an intermediate layer stack (IL) and a capping layer (CL) whereby:
first an intermediate layer stack (IL) comprising a plurality of at least two alternating high refractive index and low refractive index materials is deposited on the substrate and
   a layer of high refractive index material is deposited directly on the substrate and
secondly the patterned transparent conductor layer is deposited on top of the intermediate layer stack (IL) and
thirdly a capping layer (CL) is deposited on top of the patterned transparent conductor layer and the intermediate layer (IL) where it is not covered by the patterned transparent conductor layer.

### BRIEF DESCRIPTION OF THE DRAWINGS

FIG. 1 shows a touch screen design according to the first embodiment of the invention;

FIG. 2 shows a touch screen design comprising a capping layer (CL)

FIG. 3 shows Transmittance (left) and reflectance (right) of a layer stack according to 1) comprising a two-layer intermediate layer and approx. 30 nm patterned ITO as transparent conductive material.

FIG. 4A shows the evolution of optimized film thicknesses for a four-layer intermediate layer stack with the stacking order substrate, high_RI_#1, low_RI_#1, high_RI_#2, low_RI_#2, transparent conductive material as a function of the film thickness of the ITO-like transparent conductive material.

FIG. 4B shows the table of values with reference to FIG. 4A

FIG. 5 shows the calculated color difference from optical modeling of a touch screen solution according to FIG. 2 comprising a four-layer IL with optimized thicknesses.

FIG. 6 shows experimental data for transmittance with and without 40 nm transparent conductive material (ITO) for a layer stack comprising a single-layer CL (SL-CL) made of 800 nm high refractive index material compared to a double-layer CL (DL-CL) made of 75 nm low refractive index material on top of 800 nm high refractive index material. Resulting average transmittance (380-780 nm) is 77% for the SL-CL compared to 90% for the DL-CL stack.

### DETAILED DESCRIPTION

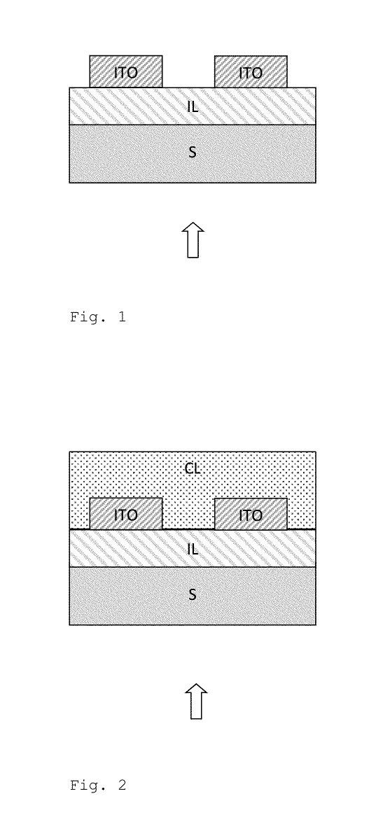

In a first embodiment the present invention provides a touch screen construction that includes a substrate and a patterned transparent conductor layer as well as an intermediate layer stack (IL) disposed between the substrate and the transparent conductor layer as depicted in FIG. 1, the intermediate layer itself comprising a plurality of at least two alternating high refractive index and low refractive index materials. The user interface is marked by the arrow on the bottom side of the figure, whereas the display side is shown as upward directed.

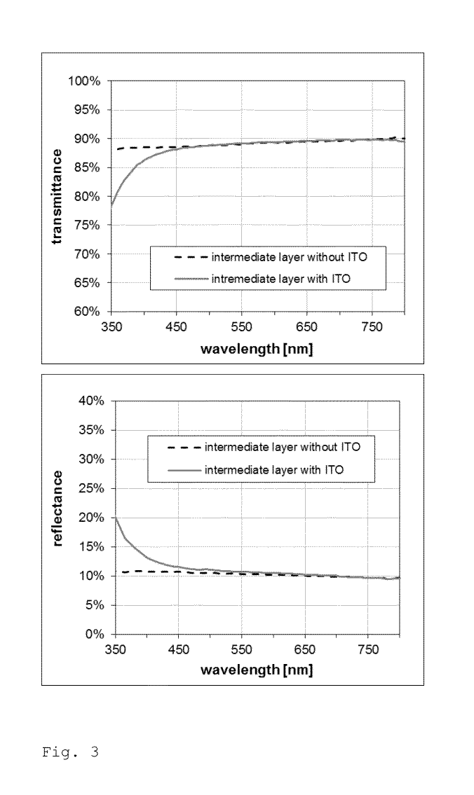

It should be mentioned that the label “ITO” as far as used within FIGS. 1 and 2 should not be seen as to refer to Indium Tin Oxide only but to all appropriate materials for transparent conductor layers. In any case the practitioner will recognize that other transparent conductive materials as known to the man of the art could be used instead of Indium Tin Oxide.

For typical touch screen solutions in many cases substantially transparent substrates like glass or plastics (e.g. PET—Polyethyleneterephthalate) both having a refractive index of 1.5 to 1.6 and a transparent conductive material like ITO (Indium Tin Oxide) having a refractive index of 1.8 to 2.0, typical high refractive index materials like Nb2O5 or TiO2 both having a refractive index of 2.3-2.4 are being used. A typical low refractive index material is SiO2 having a refractive index of about 1.46. With reference to the actual invention low refractive index materials should be used having a refractive index of 1.3 to 1.6.

A solution according to the first embodiment of the invention is more cost effective and optically well suited for applications requiring relatively thin transparent conductor film thickness of 30 nm or less resulting in typical sheet resistance values of 80 Ω/sq. FIG. 3 shows optical data for a glass substrate, a two-layer IL comprising approx. 6±1 nm high refractive index material (Nb2O5) and approx. 56±6 nm low refractive index material (SiO2) together, and approx. 30 nm transparent conductor material (ITO). Resulting color difference ΔE is 0.4 for transmittance and 1.6 for reflectance.

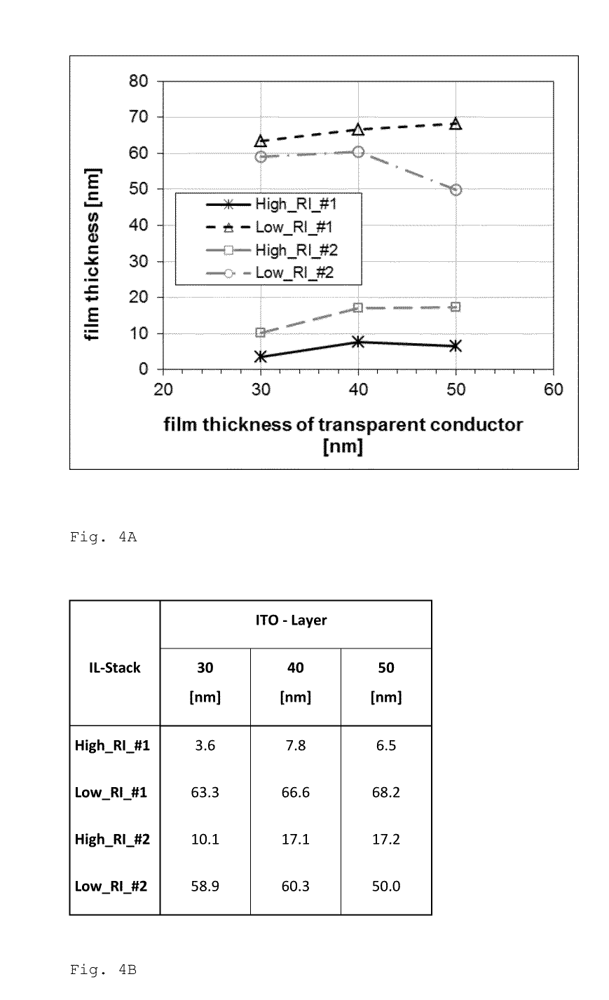

Increasing film thickness (lower sheet resistance) requires more elaborate layer stacking like replacing the two-layer IL with a four layer intermediate layer stack IL. FIG. 4A and table in FIG. 4B show optimized film thicknesses of the individual layers within the four-layer IL.

In detail FIG. 4A shows optimized layer stacks for substrates having transparent oxid conductors of different thickness, namely 30, 40 and 50 nm. This four-layer intermediate layer stack IL can be advantageously employed for both, touch screen solutions according to embodiment one and embodiment two as can be seen below respectively.

Thickness of the first layer of high reflective material deposited on the substrate can be in the range of 1 to 10 nm, preferably between 2 and 9 nm. As can be seen from FIGS. 4A and 4B dedicated thickness values of 3.6, 7.8 and 6.5 nm where applied with reference to the as mentioned examples of different thicknesses of the transparent oxide conductors, namely 30, 40 and 50 nm.

Thickness of the first layer of low reflective material deposited on the as mentioned first layer of high reflective material can be in the range of 60 to 72 nm, preferably between 63 and 69 nm. For the actual optimized examples dedicated thickness values of 63.3, 66.6 and 68.2 nm where applied.

Thickness of the second layer of high reflective material deposited on the first layer of low reflective material can be in the range of 8 to 21 nm, preferably between 10 and 19 nm. For the actual examples dedicated thickness values of 10.1, 17.1 and 17.2 nm where applied.

Thickness of the second layer of low reflective material deposited on the second layer of high reflective material can be in the range of 48 to 62 nm, preferably between 50 and 60 nm. For the actual examples dedicated thickness values of 58.9, 60.3 and 50.0 nm where applied.

All film thicknesses from experimental data as mentioned with figures and detailed description refer to refractive indices of 2.3 for the high refractive material and 1.46 for the low refractive material respectively. It is well known to the man of the art, that optical effects are governed by those refractive indices in combination with the specified film thicknesses (optical thickness). Any variation of the indices of the materials will make necessary an adaption of the respective film thicknesses in order to reach the same optical thickness nᵢ×dᵢ.

For further reducing color differences especially for relatively thick transparent conductive films of 40 nm and above a capping layer (CL) is deposited as described as a second embodiment of the actual invention. For the second embodiment an intermediate layer stack (IL) is applied together with a capping layer (CL) on top of the patterned transparent conductor layer and the intermediate layer (IL) where it is not covered by the patterned transparent conductor layer. The intermediate layer stack (IL) thereby can be designed according to the needs of different thicknesses of the transparent conductor layer and/or to different combinations of high and low refractive materials as man of the art will know. Some practical examples of the intermediate layer stack (IL) have been described with the first embodiment and can be used with the second embodiment as well.

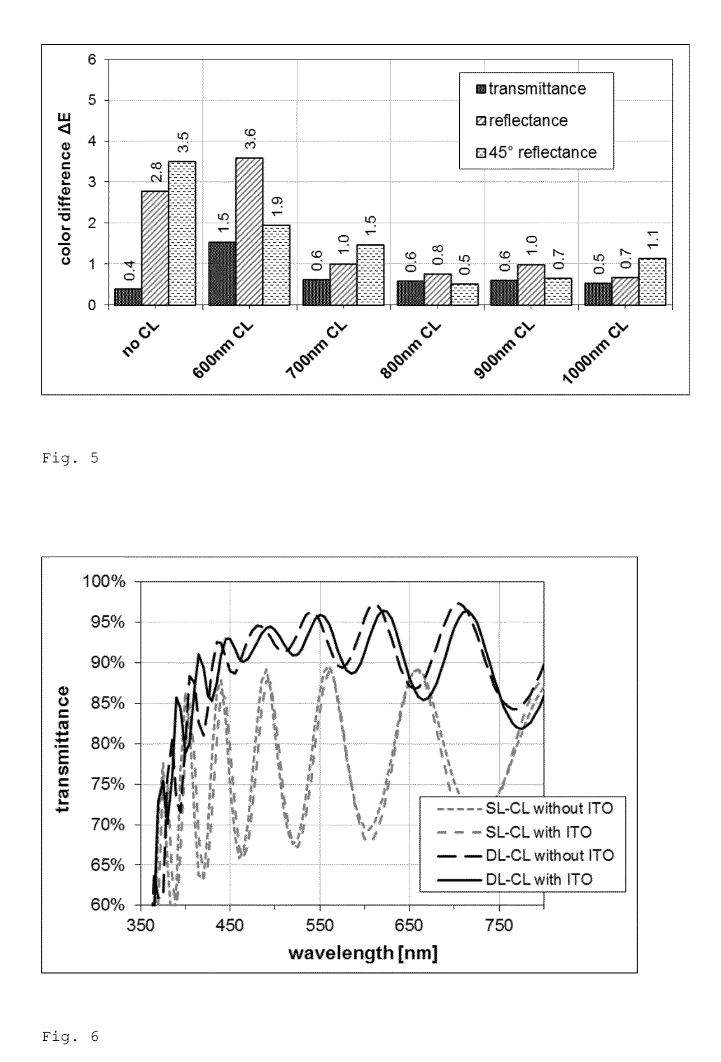

FIG. 5 Shows the calculated color difference from optical modeling of a touch screen solution according to FIG. 2 comprising a four-layer IL with optimized thicknesses according to FIG. 4, 40 nm ITO-like transparent conductive material, and a single layer CL made of high refractive index material with variable film thickness.

Therefor FIG. 5 depicts results of optical modeling if the CL consisted of only one individual layer of high refractive index material showing that about 800 nm CL thickness results in minimal color difference when optimizing normal transmittance, normal reflectance as well as 45° reflectance at the same time. Although color difference can be reduced significantly by applying a thick single layer CL (sometimes called “index matching layer” in prior art publications) overall transmittance of the touch screen device is significantly reduced due to optical interference effects (see FIG. 6). Therefore the solution according to this invention applies at least a two-layer CL e.g. comprising 75 nm low refractive index material on top of 800 nm high refractive index material in order to increase overall transmittance as shown in FIG. 6.

The capping layer of the second embodiment thereby is significantly thicker than the patterned conductor layer as depicted in FIG. 2. The capping layer itself comprises a plurality of at least two alternating high refractive index and low refractive index materials.

For transparent conductor layer films of 40 nm or more the capping layer should have a thickness of at least 10 (ten) or preferably of 15 (fifteen) times the thickness of the patterned transparent conductor layer.

With reference to FIG. 5 color differences for a four-layer intermediate layer IL according to FIG. 4 have been calculated assuming an IL without and the same IL with capping layers CLs of 600 to 1000 nm. As mentioned high refractive material having a refractive indices of 2.3 and a low refractive material having a refractive indices of 1.46 has been used for both the intermediate layer IL and the capping layer CL. For such a layer system comprising and intermediate layer IL and a capping layer CL, a thickness of the capping layer CL between 700 and 1000 nm can be applied advantageously. However man of the art will recognize that with different layer thickness of the intermediate layer IL, the transparent conductor layer and/or different refractive indices of the high and/or low refractive material, functional capping layers CL between 600 and 1100 nm or even broader could be used to produce the adequate optical thickness.

With reference to FIG. 6 a capping layer CL comprising two layers is described. Whereas application of a single layer of high refractive index material can minimize color difference ΔE of transmittance and reflectance as could be seen with FIG. 5, an additional layer of low index material can further optimize transmittance of a layer system comprising the intermediate layer IL and the capping layer CL. As can be further seen, such systems have the potential to optimize layer stacks without and with a transparent conductor layer sandwiched between. With the actual example as shown for the capping layer CL a high refractive index material layer of 800 nm thickness has been deposited on a patterned transparent conductor layer of 40 nm and the intermediate layer (IL) of FIG. 4A/B and a low refractive index material layer of 75 nm thickness have been deposited on top of the high refractive index material. Thereby a significant improvement of the average transmittance of at least about 90% could be accomplished in a wavelength range between 380 and 780 nm for the layer system. Man of the art will recognize that he may vary layer thicknesses of the high refractive index material layer as well as layer thickness of the low refractive index material layer to achieve the adequate optical thickness. E.g. a thickness variation of 800±100 nm for the high refractive index material and a thickness variation of 75±10 nm for the low refractive index material might be used for the capping layer CL.

From FIG. 5 it can be seen that applying such layer systems to a touch screen can optimize the maximum color difference ΔE between substrate areas with and without coverage of the transparent conductor layer as follows:
Transmittance: ΔEₜᵣₐₙₛ≦0.6
Reflectance: ΔE_{ref1}≦1.6
45° Reflectance: ΔE_{ref1}_{_{—}}₄₅ ≦1.5

The actual invention teaches how the intermediate layer stack according to embodiment one as well as the combination of intermediate layer stack and capping layer according to embodiment two are designed in such a way that color difference for both, transmittance and reflectance (normal reflectance as well as 45° reflectance) is significantly reduced. At the same time measures to optimize transmittance of the layer system with and without sandwiched transparent conductor layer are disclosed.

What is claimed is:

1. A touch screen having a substrate and a patterned transparent conductor layer wherein the color difference between substrate areas with and without coverage by the transparent conductor layer with respect to both reflectance and transmittance is reduced by:
an intermediate layer stack (IL) disposed between the substrate and the transparent conductor layer,
wherein the intermediate layer stack comprises a plurality of at least two alternating high refractive index and low refractive index materials.

2. A touch screen according to claim 1, wherein the touch screen is transparent having a substantially transparent substrate.

3. A touch screen according to claim 2, wherein the transparent substrate has a refractive index between 1.5 and 1.6 (limits included).

4. A touch screen according to claim 2, wherein the transparent substrate is glass or Polyethylenterephthalate (PET).

5. A touch screen according to claim 1, wherein the patterned transparent conductor layer has a refractive index of 1.8 to 2.0 (limits included).

6. A touch screen according to claim 1, wherein the patterned transparent conductor layer is ITO (Indium Tin Oxide).

7. A touch screen according to claim 1, wherein the high refractive index material has a refractive index between 2.25 to 2.4 preferably between 2.3 to 2.4 (limits included).

8. A touch screen according to claim 1, wherein the high refractive index material is Nb2O5 or TiO2.

9. A touch screen according to claim 1, wherein the low refractive index material has a refractive index between 1.3 to 1.6 (limits included).

10. A touch screen according to claim 1, wherein the low refractive index material has a refractive index of 1.46.

11. A touch screen according to claim 1, wherein the low refractive index material is SiO2.

12. A touch screen according to claim 1, wherein the film thickness of the transparent conductor layer film is 30 nm or less.

13. A touch screen according to claim 1, wherein the intermediate layer stack (IL) comprises two layers:
a high refractive index material layer of 6±1 nm thickness deposited on the substrate and
a low refractive index material layer of 56±6 nm on top of the high refractive index material layer.

14. A touch screen according to claim 1, wherein the intermediate layer stack comprises a plurality of at least four layers of alternating high refractive index and low refractive index materials.

15. A touch screen according to claim 14, wherein the four alternating high refractive index and low refractive index materials comprise a
a first layer of high reflective material having a thickness between 1 and 10 nm, preferably between 2 and 9 nm, especially preferably between 3.6 and 7.8 nm,
a first layer of low reflective material having a thickness between 60 and 72 nm, preferably between 63 and 69 nm, especially preferably between 63.3 and 68.2 nm,
a second layer of high reflective material having a thickness between 8 and 21 nm, preferably between 10 and 19 nm, especially preferably between 10.1 and 17.2 nm,
a second layer of low reflective material having a thickness between 48 and 62 nm, preferably between 50 and 60 nm, especially preferably between 50.0 and 60.3 nm (all limits included).

16. A touch screen according to claim 1, wherein an average transmittance in a wavelength range between 380 and 780 nm is at least about 90%.

17. A touch screen according to claim 1, wherein a maximum color difference ΔE between substrate areas with and without coverage by the transparent conductor layer is ΔEtrans≦0.6 for the transmittance and ΔEref1≦1.6 for the reflectance and ΔEref1_{—}45≦1.5 for the 45° reflectance.

18. A touch screen according to claim 1, comprising a capping layer (CL) situated on top of the patterned transparent conductor layer and the intermediate layer (IL) where it is not covered by the patterned transparent conductor layer.

19. A touch screen according to claim 18, wherein the capping layer CL comprises at least two layers of at least two alternating high refractive index and low refractive index materials.

20. A touch screen according to claim 18, wherein the capping layer has at least 10 (ten) times the thickness of the patterned transparent conductor layer.

21. A touch screen according to claim 18, wherein the capping layer has at least 15 (fifteen) times the thickness of the patterned transparent conductor layer.

22. A touch screen according to claim 18, wherein the thickness of the capping layer CL is between 600 and 1100 nm, preferably between 700 and 1000 nm (limits included).

23. A touch screen according to claim 18, wherein the film thickness of the transparent conductor layer film is 40 nm or more.

24. A touch screen according to claim 18, wherein the capping layer CL comprises two-layers:
a high refractive index material layer of 800±100 nm thickness deposited on the patterned transparent conductor layer and the intermediate layer (IL), where it is not covered by the transparent conductor layer, and a low refractive index material layer of 75±10 nm thickness deposited on top of the high refractive index material.

25. A method of manufacturing a touch screen with reduced color difference ΔE between substrate areas with and without coverage by a transparent conductor layer according to claim 1 whereby:
first an intermediate layer stack (IL) comprising a plurality of at least two alternating high refractive index and low refractive index materials is deposited on the substrate and a layer of high refractive index material is deposited directly on the substrate and
secondly the patterned transparent conductor layer is deposited on top of the intermediate layer stack (IL).

26. A method of manufacturing a touch screen with reduced color difference ΔE between substrate areas with and without coverage by a transparent conductor layer according to claim 18 whereby:
first an intermediate layer stack (IL) comprising a plurality of at least two alternating high refractive index and low refractive index materials is deposited on the substrate and a layer of high refractive index material is deposited directly on the substrate and
secondly the patterned transparent conductor layer is deposited on top of the intermediate layer stack (IL) and
thirdly a capping layer (CL) is deposited on top of the patterned transparent conductor layer and the intermediate layer (IL) where it is not covered by the patterned transparent conductor layer.
